(19) United States
(12) Patent Application Publication
(10) Pub. No.: US 2026/0075528 A1
(43) Pub. Date: Mar. 12, 2026

(54) WAKE-UP SIGNAL PROCESSING METHOD, APPARATUS AND DEVICE

(71) Applicant: Spreadtrum Semiconductor (Nanjing) Co., Ltd., Nanjing (CN)

(72) Inventors: Yongzhao CAO, Nanjing (CN); Zhenzhu LEI, Nanjing (CN); Huayu ZHOU, Nanjing (CN)

(73) Assignee: Spreadtrum Semiconductor (Nanjing) Co., Ltd., Nanjing (CN)

(21) Appl. No.: 19/103,163

(22) PCT Filed: Aug. 11, 2023
(86) PCT No.: PCT/CN2023/112577

§ 371 Date: Feb. 11, 2025

(30) Foreign Application Priority Data
Aug. 11, 2022 (CN) 202210963482.5

(51) Int. Cl. H04W 52/02

(52) U.S. Cl. CPC H04W 52/0235

(57) ABSTRACT

The present disclosure provides a wake-up signal processing method. The method includes: a network device modulating a first wake-up signal with a low-rate modulation scheme to obtain a low-rate wake-up signal, superimposing the low-rate wake-up signal with an OFDM signal to obtain a superimposed signal, and transmitting the superimposed signal to a terminal device.

### CROSS-REFERENCE TO RELATED APPLICATIONS

This application is a National Stage of International Application No. PCT/CN2023/112577, filed on Aug. 11, 2023, which claims priority to Chinese Patent Application No. 202210963482.5, filed with the China National Intellectual Property Administration on Aug. 11, 2022, both of which are incorporated by reference in their entireties.

### TECHNICAL FIELD

Embodiments of the present disclosure relate to the field of communication technology and, in particular, to a wake-up signal processing method, apparatus and device.

### BACKGROUND

In wireless communication technology, such as the 5th generation mobile communication technology (5G), when a user equipment (UE) is in an idle state (Radio Resource Control IDLE, RRC-IDLE) or an inactive state (RRC-INACTIVE), the UE needs to be periodically awakened and listen to a paging message within a paging occasion (PO). This periodic wake-up mode consumes significant power for the UE, resulting in low energy efficiency of the UE.

In order to achieve the purpose of energy saving when the UE is in an idle or inactive state, the 3rd Generation Partnership Project (3GPP) has introduced a paging enhancement function, namely a paging early indication (PEI), in the R17 standard (Release 17) for 5G new radio (NR) systems. PEI is used to inform the UE whether it needs to wake up and listen to a paging message within a paging occasion (PO) before the PO. In this way, the power consumption of the UE can be reduced to a certain extent.

However, the UE also receives PEI periodically, which causes a certain delay in waking up the UE and cannot meet actual needs of delay-sensitive services. That is, the method for waking up the UE in the related art cannot reduce the energy consumption while simultaneously meeting latency requirements.

### SUMMARY

The present disclosure provides a wake-up signal processing method, apparatus and device.

In a first aspect, an embodiment of the present disclosure provides a wake-up signal processing method, including:
modulating a first wake-up signal with a low-rate modulation scheme to obtain a low-rate wake-up signal;
superimposing the low-rate wake-up signal with an orthogonal frequency division multiplexing (OFDM) signal to obtain a superimposed signal;
transmitting the superimposed signal.

In a second aspect, an embodiment of the present disclosure provides a wake-up signal processing method, including:
receiving a superimposed signal, where the superimposed signal is obtained by superimposing a low-rate wake-up signal with an orthogonal frequency division multiplexing (OFDM) signal, and the low-rate wake-up signal is obtained by modulating a first wake-up signal with a low-rate modulation scheme;
demodulating the superimposed signal to obtain the first wake-up signal.

In a third aspect, an embodiment of the present disclosure provides a wake-up signal processing device, including a processor and a memory:
the memory stores a computer-executable instruction;
the processor executes the computer-executable instruction stored in the memory to implement the method as described in any one of the first aspect or the second aspect.

In a fourth aspect, an embodiment of the present disclosure provides a non-transitory computer-readable storage medium which stores a computer-executable instruction, when the computer-executable instruction is executed, the method as described in any one of the first aspect or the second aspect is implemented.

### BRIEF DESCRIPTION OF DRAWINGS

In order to explain the technical scheme in embodiments of the present disclosure or the related art more clearly, the drawings needed to be used in the description of the embodiments or the related art will be briefly introduced below. Obviously, the drawings in the following description are some embodiments of the present disclosure, and for those skilled in the art, other embodiments can be obtained according to these drawings without paying creative effort.

FIG. 1 is a schematic diagram of an application scenario provided by an embodiment of the present disclosure.

FIG. 2 is a schematic diagram of a network architecture provided by an embodiment of the present disclosure.

FIG. 3 is a schematic diagram of early 5G network paging.

FIG. 4 is a schematic diagram of a DCI-based PEI.

FIG. 5 is a schematic diagram of paging group grouping.

FIG. 6 is a schematic flowchart of a wake-up signal processing method provided by an embodiment of the present disclosure.

FIG. 7 is a schematic diagram of non-return-to-zero encoding provided by an embodiment of the present disclosure.

FIG. 8 is a schematic diagram of Manchester encoding provided by an embodiment of the present disclosure.

FIG. 9 is a schematic diagram of unipolar return zero encoding provided by an embodiment of the present disclosure.

FIG. 10 is a schematic diagram of differential binary phase encoding provided by an embodiment of the present disclosure.

FIG. 11 is a schematic diagram of Miller encoding provided by an embodiment of the present disclosure.

FIG. 12 is a schematic diagram of pulse interval encoding provided by an embodiment of the present disclosure.

FIG. 13 is a schematic diagram of pulse position encoding provided by an embodiment of the present disclosure.

FIG. 14 is a schematic diagram of bi-phase space encoding provided by an embodiment of the present disclosure.

FIG. 15 is a schematic diagram of pulse width encoding provided by an embodiment of the present disclosure.

FIG. 16 is a schematic diagram of a signal waveform of OOK modulation.

FIG. 17 is a schematic diagram of a signal waveform of amplitude shift keying (ASK) modulation.

FIG. 18 is a schematic flowchart of another wake-up signal processing method provided by an embodiment of the present disclosure.

FIG. 19 is a schematic flowchart of yet another wake-up signal processing method provided by an embodiment of the present disclosure.

FIG. 20 is a structural schematic diagram of a wake-up signal processing apparatus provided by an embodiment of the present disclosure.

FIG. 21 is a structural schematic diagram of another wake-up signal processing apparatus provided by an embodiment of the present disclosure.

FIG. 22 is a structural schematic diagram of a wake-up signal processing device provided by an embodiment of the present disclosure.

### DESCRIPTION OF EMBODIMENTS

In order to enable those skilled in the art to better understand the technical solution of the present disclosure, the present disclosure is further described in detail below with reference to the drawings and embodiments. It should be understood that the specific embodiments and drawings described herein are only used to explain the present disclosure, but not to limit the present disclosure.

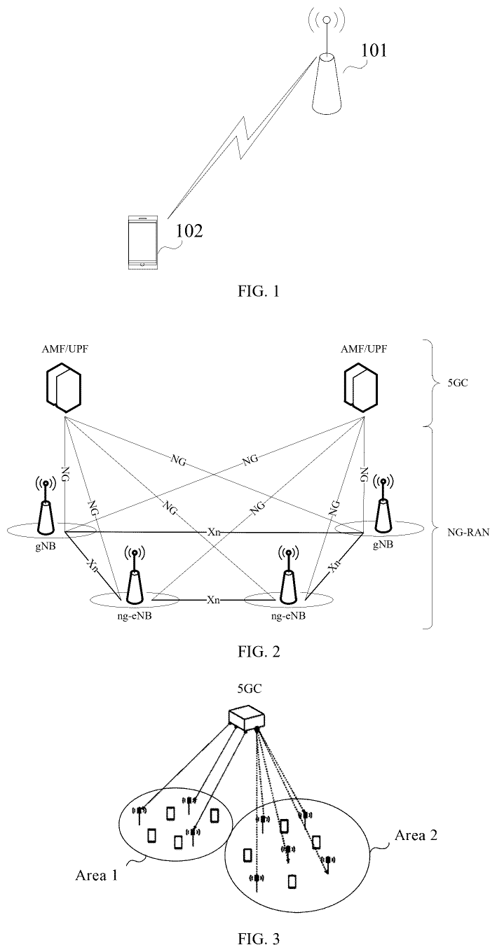

FIG. 1 is a schematic diagram of an application scenario provided by an embodiment of the present disclosure. Refer to FIG. 1, which includes a network device 101 and a terminal device 102, they communicate via a wireless network.

The network device 101 can be any kind of device with wireless transceiver functions. The network device includes but is not limited to: various kinds of base stations (a macro base station, a micro base station, a pole station or a repeater (RP), etc.), an evolved Node B (eNB), a radio network controller (RNC), a Node B (NB), a base station controller (BSC), a base transceiver station (BTS), a home base station (e.g., a home evolved NodeB, or a home Node B, HNB), a baseband unit (BBU), an access point (AP), a wireless relay node, a wireless backhaul node, a transmission point (TP) or a transmission and reception point (TRP) in a wireless fidelity (WiFi) system, or may be a gNB or a transmission point (TRP or TP) in a 5G system (such as an NR system), one antenna panel or a group of (including multiple antenna panels) antenna panels of a base station in a 5G system, or may be a network node constituting a gNB or a transmission point, such as a baseband unit (BBU) or a distributed unit (DU).

In some deployments, the gNB may include a centralized unit (CU) and a DU. The gNB may also include an active antenna unit (AAU). The CU implements some functions of the gNB, and the DU implements some functions of the gNB. For example, the CU is responsible for processing non-real-time protocols and services, and implementing functions of radio resource control (RRC) and packet data convergence protocol (PDCP) layers. The DU is responsible for processing physical layer protocols and real-time services, and implementing functions of a radio link control (RLC) layer, a medium access control (MAC) layer and a physical (PHY) layer. The AAU implements some physical layer processing functions, radio frequency processing and related functions of active antennas. Since information of the RRC layer will eventually become information of the PHY layer, or be converted from information of the PHY layer, under this architecture, high-level signaling, such as RRC layer signaling, can also be considered to be transmitted by DU, or by DU+AAU. It can be understood that the network device can be a device including one or more of CU node(s), DU node(s), and AAU node(s). In addition, the CU may be classified as a network device in a radio access network (RAN), and the CU may also be classified as a network device in a core network (CN). The embodiments of the present disclosure do not limit the specific type or name of the network device 101.

The terminal device 102 can also be called a user equipment (UE), an access terminal, a user unit, a user station, a mobile site, a mobile station, a remote station, a remote terminal, a mobile device, a user terminal, a terminal, a wireless communication equipment, a user agent or a user apparatus, etc. The terminal device 102 may specifically be a device that provides voice/data connectivity to a user, such as a handheld device or a vehicle-mounted device with a wireless connection function. Specifically, it can be a mobile phone, a tablet computer (pad), a computer with wireless transceiver functions (such as a laptop, a handheld computer, etc.), a mobile internet device (MID), a virtual reality (VR) device, an augmented reality (AR) device, a wireless terminal in industrial control, a wireless terminal in self-driving, a wireless terminal in remote medical, a wireless terminal in a smart grid, a wireless terminal in transportation safety, a wireless terminal in a smart city, a wireless terminal in a smart home, a cellular phone, a cordless phone, a session initiation protocol (SIP) phone, a wireless local loop (WLL) station, a personal digital assistant (PDA), a handheld device with wireless communication functions, a computing device or a processing device connected to a wireless modem, a vehicle-mounted device, a wearable device, a terminal device in a 5G network, or a terminal device in a future evolved public land mobile network (PLMN), etc.

A wearable device can also be called a wearable smart device, which is a general term for wearable devices which are developed by applying wearable technology to design daily wear intelligently, such as glasses, gloves, watches, clothing and shoes. Wearable devices are portable devices that are worn directly on the body or integrated into users' clothing or accessories. Wearable devices are not just hardware devices, but also possess powerful functions through software support, data interaction, and cloud interaction. In a broad sense, wearable smart devices include those that are fully functional, large in size, and can achieve complete or partial functions without relying on smartphones, such as smart watches or smart glasses, as well as those that only focus on a certain type of application function and need to be used in conjunction with other devices (e.g., smartphones), such as various smart bracelets and smart jewelry for vital sign monitoring.

In addition, the terminal device 102 may also be a terminal device in an Internet of Things (IoT) system. IoT is an important part of the future development of information technology, and its main technical feature is to connect objects to the network through communication technology, thereby realizing an intelligent network that interconnects people and machines, as well as things and objects. IoT technology can achieve massive connections, deep coverage, and terminal power saving through, e.g., narrow band (NB) technology.

In addition, the terminal device 102 may also include sensors such as a smart printer, a train detector, or a gas station, and the main functions include collecting data (part of terminal devices), receiving control information and downlink data from network devices, and sending electromagnetic waves to transmit uplink data to network devices.

Of course, the terminal device 102 may also be a chip or a chip module, etc. The embodiments of the present disclosure do not limit the specific type or name of the terminal device 102.

FIG. 2 is a diagram of a network architecture provided by an embodiment of the present disclosure. As shown in FIG. 2, the 5G network architecture mainly includes a 5G access network (NG-RAN) and a 5G core network (5GC). The 5G wireless access network mainly includes two types of nodes (base stations): gNB and ng-eNB. Among them, the gNB node can be a node that provides NR user plane and control plane protocol terminations to the UE and is connected to the 5GC via an NG interface. The ng-eNB node is a node that provides E-UTRA user plane and control plane protocol terminations to the UE and is connected to the 5GC via the NG interface. The gNB is used for independent 5G networking, while the ng-eNB is used for backward compatibility with 4G networks. An Xn interface is a network interface between nodes in NG-RAN. The 5G network also includes a core unit, including an access and mobility management function (AMF) and a user plane function (UPF). The AMF is responsible for user access and mobility management, and the UPF is responsible for user plane processing.

5G systems are designed and developed for mobile phones and vertical use cases. In addition to latency, reliability, and availability, UE energy efficiency is also critical to 5G. Currently, 5G devices may need to be charged weekly or daily, depending on individual usage. Generally speaking, 5G devices consume tens of milliwatts in an RRC idle or inactive state and consume hundreds of milliwatts in an RRC connected state. Designing for extended battery life is imperative for increased energy efficiency and improved user experience. For UEs without continuous energy sources, such as those using small rechargeable batteries and single button cells, energy efficiency is even more critical. In vertical use cases, sensors and actuators are widely used for monitoring, measuring, charging, etc. Generally speaking, their batteries are non-rechargeable and are expected to last at least a few years, as described in the TR38.875 standard. Additionally, it is a challenge for wearable devices to maintain typical battery capacity for up to 1-2 weeks as needed, the wearable devices can include smart watches, rings, electronic health-related devices, and medical monitoring devices.

When the terminal device 102 is in the RRC idle state or the RRC inactive state, the terminal device still needs to be awakened within the paging occasion PO and monitor the paging message. However, not all terminal devices are paged during the paging occasion PO. For terminal devices that are not paged, frequent awakening and monitoring of paging messages causes unnecessary power consumption in terminal devices, resulting in rapid battery depletion of the terminal devices. In order to achieve the goal of energy saving for terminal devices, 3GPP R17 introduced the paging early indication PEI function to solve the problem of significant power loss in terminal devices due to high error paging or infrequent paging in early standards such as R15.

Exemplarily, FIG. 3 shows a schematic diagram of 5G early network paging. As shown in FIG. 3, the 5G core network (5GC) normally pages (solid line in FIG. 3) terminal devices in area 1, but also mistakenly pages (dashed line in FIG. 3) terminal devices in area 2. It can be seen that the error rate of 5G early paging was high, resulting in relatively high power consumption of terminal devices.

The paging early indication introduced in R17 notifies the terminal device, before the paging occasion PO, whether the terminal device must monitor the paging channel. If the terminal device does not need to monitor the paging channel, it can skip the time-frequency synchronization before PO and does not need to be awakened. PEI can notify the terminal device through downlink control information (DCI) carried in a physical downlink control channel or through a reference signal. In addition, PEI can carry sub-grouping information to divide terminal devices sharing the same paging occasion into sub-groups, thereby avoiding low group paging rate and reducing false paging alarms.

As an enhancement to traditional paging. PEI helps saving UE's power consumed when decoding false paging messages. Compared with the basic paging process of early standards such as R15, PEI can save 17%-34% of energy for UE, and the specific energy saving value depends on wireless conditions such as the UE's signal to interference plus noise ratio (SINR). Furthermore, if PEI has supplementary sub-grouping information, an additional 10% of energy can be saved while also mitigating the impact of high group paging rates: the SIBI type in system information SIB (System Information Block, SIB) can inform the terminal device about configuration related to the PEI through the PEI-config 1E information element.

In view of the PEI function, a DCI-based PEI can flexibly include a sub-grouping indication and may also include a short message and other information, so DCI is selected as the first choice. PEI implies a finite-sized DCI search space or sequence, which is transmitted from the base station (gNB) before each paging occasion.

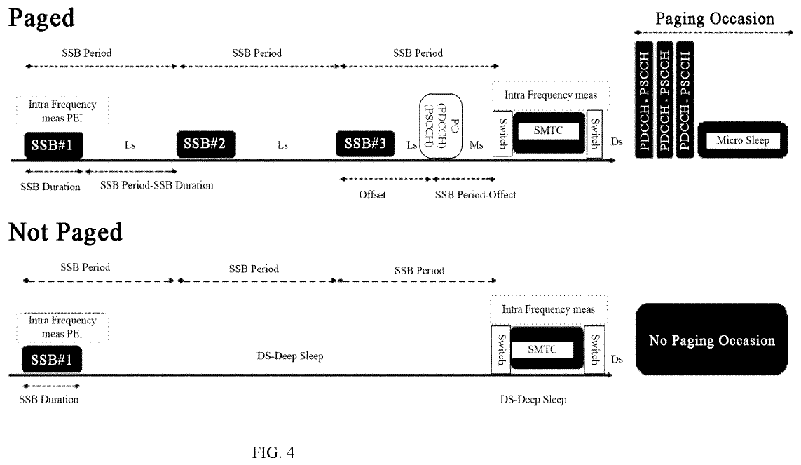

FIG. 4 shows a schematic diagram of a DCI-based PEI. In combination with FIG. 4, a terminal device in an idle state or an inactive state monitors the search space of the PEI, and upon detecting the current PEI indication, the terminal device monitors the next PO: otherwise, the terminal device enters into deep sleep and skips monitoring the PO. Compared with actual paging of a physical downlink control channel (PDCCH), the achievable power saving gain is mainly due to the more limited PEI search space. Therefore, for terminal devices that are not paged, PEI can reduce the number of unnecessary decoding in PO, that is, reduce false paging alarms.

In addition, FIG. 5 shows a schematic diagram of paging group grouping. In combination with FIG. 5, PEI DCI or sequence may also be defined for a specific idle/inactive terminal device group in R17. Specifically, terminal devices in an idle state or an inactive state are grouped into several paging groups (group A, group B, group C) through several introduced grouping methods, and the PEI DCI is scrambled in a group-specific manner. Therefore, when a terminal device in an idle state or an inactive state calculates an erroneous cyclic redundancy check (CRC) after decoding PEI DCI using a scrambling code for its own paging group, the terminal device assumes that the transmitted PEI is intended for one or more other paging groups and skips the PO, thereby further reducing false paging alarms.

It can be seen that the PEI function introduced by 3GPP in the R17 standard can reduce the power consumption of a terminal device in an idle or an inactive state to a certain extent, thus achieving the purpose of energy saving. However, the terminal device also receives PEI periodically, which causes a delay in waking up the terminal device and cannot meet the needs of some delay-sensitive and energy-sensitive services. For example, in a fire detection and extinguishing use case, the actuator should close the fire shutter and open the fire sprinkler within 1 to 2 seconds after the sensor detects a fire, a relatively long wake-up cycle cannot meet latency requirements. Therefore, the method for waking up terminal devices in the related art cannot reduce power consumption while simultaneously meeting latency requirements. In the R18 standard (Release 18), an ultra-low power consumption mechanism that supports low latency (such as lower than the latency of unconnected discontinuous reception (IDLE DRX, eDRX)) is urgently needed.

In the embodiments of the present disclosure, a network device modulates a first wake-up signal with a low-rate modulation scheme to obtain a low-rate wake-up signal, superimposes the low-rate wake-up signal with an OFDM signal to obtain a superimposed signal, and transmits the superimposed signal to a terminal device. In this way, due to the significant rate difference between the low-rate wake-up signal and the OFDM signal, the terminal device can demodulate the superimposed signal with a low-power demodulation scheme, thereby reducing power consumption of the terminal device. In addition, on the basis of low power consumption, the terminal device can detect the wake-up signal more frequently, enabling real-time reception of the wake-up signal, thereby realizing rapid wake-up of the terminal device and meeting the requirements of delay-sensitive services.

In the following, the solutions shown in the present disclosure will be described in detail through specific embodiments. It should be noted that the following embodiments may exist independently or in combination with each other, and the same or similar contents will not be described repeatedly in different embodiments.

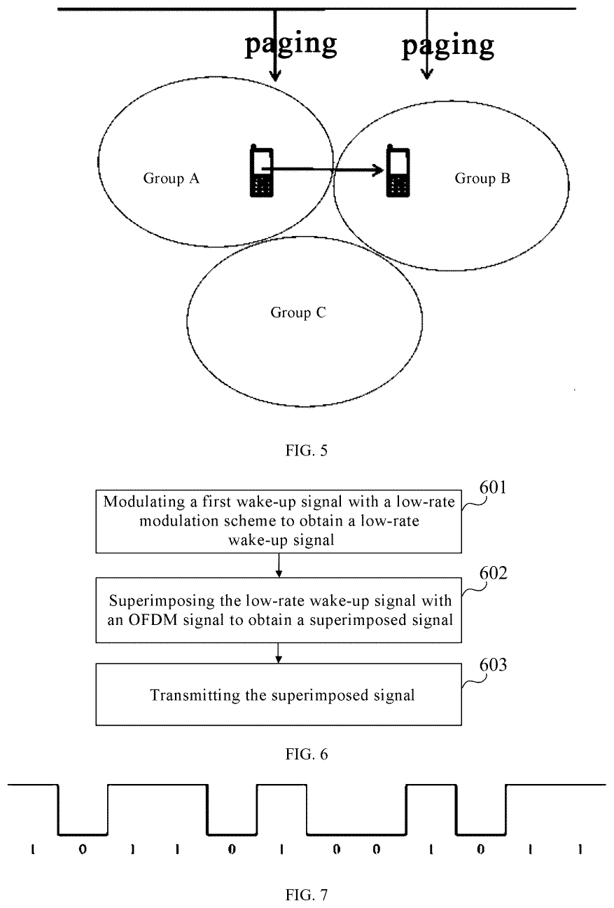

Next, the process of processing the wake-up signal will be described in conjunction with the embodiment shown in FIG. 6.

FIG. 6 is a schematic flowchart of a wake-up signal processing method provided by an embodiment of the present disclosure. Refer to FIG. 6, the method may include:

S601, modulating a first wake-up signal with a low-rate modulation scheme to obtain a low-rate wake-up signal.

In an embodiment of the present disclosure, a first wake-up signal may refer to a signal transmitted from a network device to a terminal device for waking up the terminal device. The first wake-up signal may be represented by a LP-WUS signal (Low-Power Wake-Up Signal), corresponding to a low-power wake-up signal receiver (LP-WUR). Of course, the first wake-up signal may also be represented by other names or other abbreviations, which is not limited in the embodiments of the present disclosure. The low-rate modulation scheme may refer to a modulation scheme that can modulate the first wake-up signal into a low-rate signal, which may specifically be On-Off Keying (OOK) modulation, pulse modulation, or modulation based on a specific function, etc., and the embodiment of the present disclosure is not limited thereto. The low-rate wake-up signal may refer to a modulated low-rate signal.

S602, superimposing the low-rate wake-up signal with an OFDM signal to obtain a superimposed signal.

In an embodiment of the present disclosure, an OFDM signal may refer to a multi-carrier transmission signal in a 5G system, which is implemented based on orthogonal frequency division multiplexing (OFDM) technology. The OFDM signal is a high-speed multi-carrier transmission signal widely used in 5G NR, which can realize parallel transmission of high-speed serial data, it has good resistance to multipath fading, and can support multi-user access.

The network device can superimpose and fuse a low-rate wake-up signal with an OFDM signal, that is, modulate a low-rate wake-up signal onto an OFDM signal to obtain a superimposed signal. It should be noted that when the network device needs to transmit data to the terminal device, the OFDM signal can be a time-domain waveform of a modulated data symbol. When the network device does not need to transmit data, the OFDM signal can also be a time-domain waveform of an unmodulated data symbol, and the signal superimposition can be performed based on actual needs of the network device, which is not limited in the embodiments of the present disclosure.

S603, transmitting the superimposed signal.

In an embodiment of the present disclosure, the network device may transmit a superimposed signal to the terminal device. Due to the significant rate difference between the low-rate wake-up signal and the OFDM signal, the terminal device can quickly demodulate the first wake-up signal based on the superimposed signal, and then determine whether the terminal device itself needs to be awakened, thereby reducing the wake-up delay while reducing the power consumption of the terminal device.

In the wake-up signal processing method provided by the present disclosure, a network device modulates a first wake-up signal with a low-rate modulation scheme to obtain a low-rate wake-up signal, superimposes the low-rate wake-up signal with an OFDM signal to obtain a superimposed signal, and transmits the superimposed signal to a terminal device. In this way, due to the significant rate difference between the low-rate wake-up signal and the OFDM signal, the terminal device can quickly demodulate the two signals based on the superimposed signal, thereby reducing the power consumption of the terminal device. At the same time, on the basis of low power consumption, the terminal device can always be in a state of detecting the wake-up signal and receive the wake-up signal in real-time, thereby allowing for rapid wake-up of the terminal device and meeting the needs of delay-sensitive services.

In a possible implementation, the first wake-up signal includes a one-bit indication: or,
the first wake-up signal includes a one-bit indication and an identifier: the identifier includes at least one of an identifier of a terminal device or an identifier of a group to which a terminal device belongs.

In an embodiment of the present disclosure, a one-bit indication may also be referred to as a single-bit (bit) indication. The one-bit indication can be used to indicate whether a terminal device needs to be awakened. For example, the one-bit indication with a value of 1 can indicate waking up the terminal device, and the one-bit indication with a value of 0 can indicate that the terminal device does not need to be awakened. The specific value and corresponding meaning can be set based on actual needs, which is not limited in the embodiments of the present disclosure. The form of one-bit indication is relatively concise, and the length of the first wake-up signal is also relatively short, but the content carried therein is limited. If a first wake-up signal is generated based on only a one-bit indication, the terminal device may not be able to determine whether it needs to process the single-bit indication. In this case, it may need to combine other signals to determine an identifier or other information corresponding to the one-bit indication.

In an embodiment of the present disclosure, the first wake-up signal can also be generated based on a one-bit indication and an identifier, and the identifier can specifically be an identifier of the terminal device (UE ID) or a group identifier (Group ID) to which the terminal device belongs. Correspondingly, the first wake-up signal may specifically be in the form of a one-bit indication and an identifier of the terminal device, a one-bit indication and a group identifier to which the terminal device belongs, a one-bit indication and an identifier of a terminal device and a group identifier to which the terminal device belongs, and the like. In this way, the length of the first wake-up signal increases and the content carried therein is enriched. Based on the first wake-up signal, the terminal device can quickly determine whether it needs to execute the first wake-up signal, thereby ensuring the accuracy of signal transmission and execution.

In a possible implementation, the first wake-up signal is a signal obtained after simple encoding.

In a possible implementation, the simple encoding includes any of the following:
non-return-to-zero encoding, Manchester encoding, unipolar return zero encoding, differential binary phase encoding. Miller encoding, modified Miller encoding, pulse interval encoding, pulse position encoding, bi-phase space encoding, pulse width encoding.

In an embodiment of the present disclosure, the first wake-up signal may be a signal obtained by performing simple encoding on an initial wake-up signal: or, the network device may first perform simple encoding on a first wake-up signal and then perform modulation with a low-rate modulation scheme. By performing simple encoding on the wake-up signal, the encoding gain can be increased and the performance can be improved. The simple encoding method can be any one of the following (1) to (10). Of course, other encoding methods except the following encoding methods can also be used, which is not limited in the embodiments of the present disclosure. In the following, various simple encoding methods will be introduced.

(1) Non-return-to-zero (Non Return Zero, NRZ) encoding. FIG. 7 shows a schematic diagram of non-return-to-zero encoding according to an embodiment of the present disclosure. As shown in FIG. 7, the non-return-to-zero encoding uses a high level to represent a binary “1” and a low level to represent a binary “0”. The non-return-to-zero encoding is not suitable for transmission, mainly for the following reasons: in the presence of direct current, it is generally difficult for a channel to transmit frequency components near zero frequency: the decision threshold at the receiving end is related to the signal power, which makes it inconvenient to use: it cannot be used directly to extract a bit synchronization signal, because NRZ does not contain frequency component(s) of the bit synchronization signal; and the transmission line is required to have a ground connection. In an embodiment of the present disclosure, the non-return-to-zero encoding is used to achieve simple encoding of the wake-up signal, thus increasing the encoding gain and improving the performance.

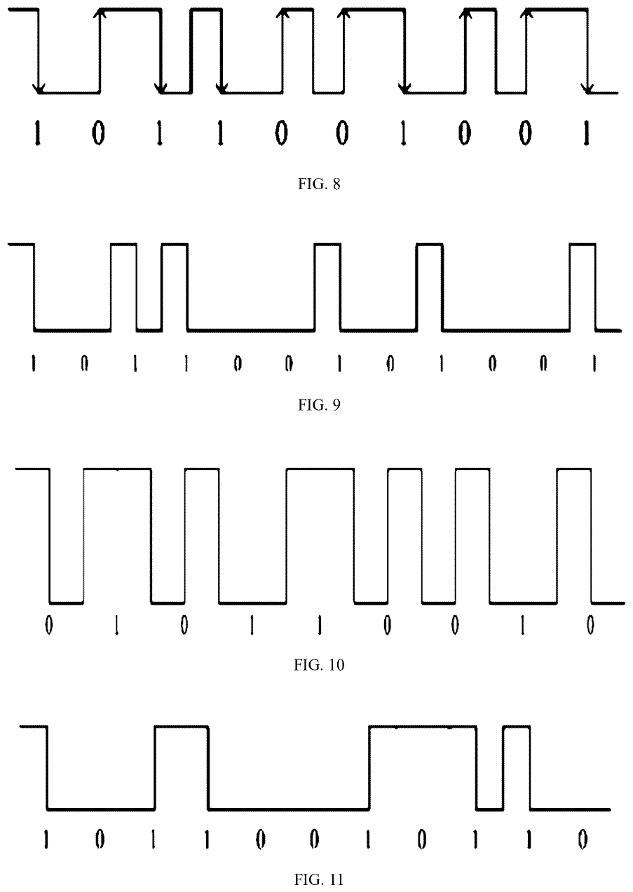

(2) Manchester encoding. Manchester encoding is also called Split-Phase coding (Split-Phase coding). FIG. 8 shows a schematic diagram of Manchester encoding according to an embodiment of the present disclosure. As shown in FIG. 8, a value of a bit is represented by the change in level (rising or falling) at half a bit period within the bit length. A negative transition at half a bit period represents a binary “1”, and a positive transition at half a bit period represents a binary “0”. That is, the value of the bit is represented by a level change (rising/falling) at half a bit period (50%). A negative transition at half a bit period (i.e., a level change from 1 to 0)) represents a binary “1”, and a positive transition represents a binary “0)”. Manchester encoding has the following features.

Feature 1: Manchester encoding is helpful in detecting data transmission errors when using load modulation or backscatter modulation of a load wave. This is because within a bit length, a “no change” state is not allowed.

Feature 2: when data bits transmitted simultaneously have different values, the received rising and falling edges cancel each other out, resulting in an uninterrupted load wave signal throughout the entire bit length. Since this state is not allowed, the receiving end can use this error to determine a specific location where the collision occurred.

Feature 3: since change occurs in the middle of each code element in Manchester encoding, the receiving end can easily use it as a synchronization clock.

(3) Unipolar return zero (Unipolar RZ) encoding. FIG. 9 shows a schematic diagram of unipolar return zero encoding according to an embodiment of the present disclosure. As shown in FIG. 9, when code 1 is sent, a positive current is sent, but the duration of the positive current is shorter than the time width of a code element, that is, a narrow pulse is sent; when code 0 is sent, no current is sent at all. This unipolar return zero encoding can be used to extract the bit synchronization signal.

(4) Differential Binary Phase (DBP). FIG. 10 shows a schematic diagram of differential binary phase encoding according to an embodiment of the present disclosure. As shown in FIG. 10, in the differential binary phase encoding, any edge in a half bit period represents a binary “0”, while no edge represents a binary “1”. In addition, the level is inverted at the beginning of each bit period. Therefore, reconstruction of the bit beat is easier for a receiver.

(5) Miller encoding. FIG. 11 shows a schematic diagram of Miller encoding according to an embodiment of the present disclosure. As shown in FIG. 11, in Miller encoding, any edge in a half bit period represents a binary “1”, while an unchanged level in the next bit period represents a binary “0”. A series of bit periods begin with a level change, and reconstruction of the bit beat is easier for a receiver.

The following table 1 is the specific encoding rule of Miller encoding:

TABLE 1

| bit(i − 1) | bit(i) | Encoding rule of Miller encoding |
|---|---|---|
| / | 1 | Starting position of bit i does not change, middle |
| | | position changes |
| 0 | 0 | Starting position of bit i changes, middle position |
| | | does not change |
| 1 | 0 | Starting position of bit i does not change, middle |
| | | position does not change |

As shown in Table 1, for the original symbol “1”, it is represented by no change at the beginning of the code element but a change at the center point, that is, it is represented by 10 or 01; for the original symbol “0”, it is processed in different ways depending on whether it is a single “0” or continuous “0”. When it is a single “0”, the level before the “0” is kept unchanged, that is, the level does not change at the boundary of the code element, and the level does not change either at the middle point of the code element. For two continuous “0”, a level change occurs at the boundary between the two continuous “0”.

(6) Modified Miller encoding. The encoding rule of the modified Miller encoding is: a presence of a narrow pulse in the middle of each data bit represents “1”, and no narrow pulse in the middle of the data represents “0”. When there are continuous “0s”, a narrow pulse is added to the beginning of the data starting from the second “0”. There is also a narrow pulse at the beginning of the start bit, and the end bit is represented by “0”. If there are two continuous bits without narrow pulses at beginning and middle parts, it means there is no information.

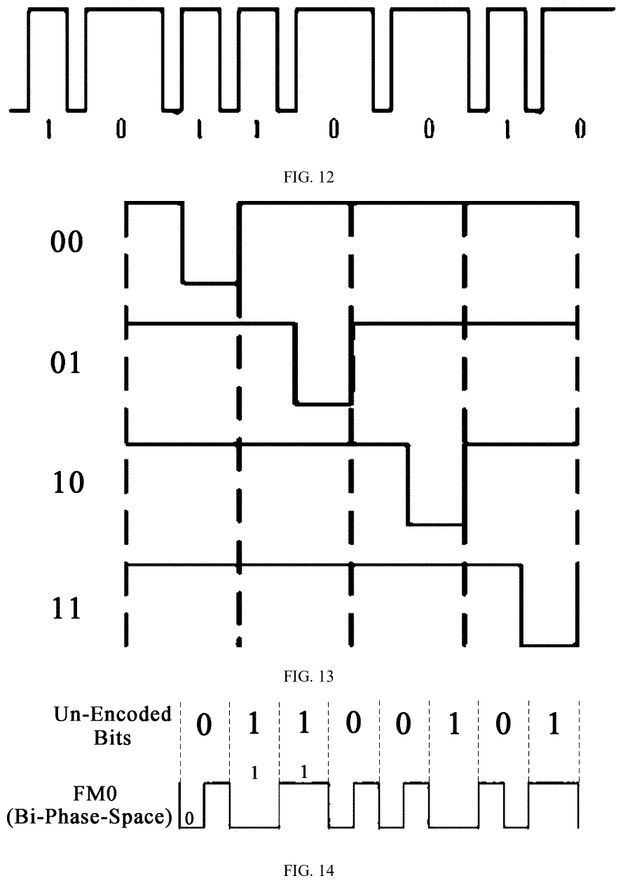

(7) Pulse interval encoding. FIG. 12 shows a schematic diagram of pulse interval encoding according to an embodiment of the present disclosure. As shown in FIG. 12, for pulse interval encoding, a pause duration t before the next pulse represents a binary “1”, while a pause duration 2t before the next pulse represents a binary “0”. Exemplarily, this encoding method is used for data transmission from a reader to an electronic tag in an inductively coupled RF system. Since the pulse conversion time is very short, it is possible to ensure that the RF tag is continuously supplied with energy from the high frequency field of the reader during data transmission.

(8) Pulse position encoding (Pulse Position Modulation, PPM). FIG. 13 shows a schematic diagram of pulse position encoding by an embodiment of the present disclosure. As shown in FIG. 13, the pulse position encoding is similar to the pulse interval encoding described above, except that in pulse position encoding, the width of each data bit is consistent. The pulse represents “00” in the first time period, “01” in the second time period, “10” in the third time period, and “11” in the fourth time period.

(9) Bi-phase space (FMO) encoding. FIG. 14 shows a schematic diagram of bi-phase space encoding according to an embodiment of the present disclosure. As shown in FIG. 14, the working principle of FMO encoding is to use level changes within a bit window to represent logic. If the level flips at the beginning of the bit window; it indicates a logical “1”. If the level flips in the middle of the bit window in addition to at the beginning of the bit window; it indicates a logical “0”.

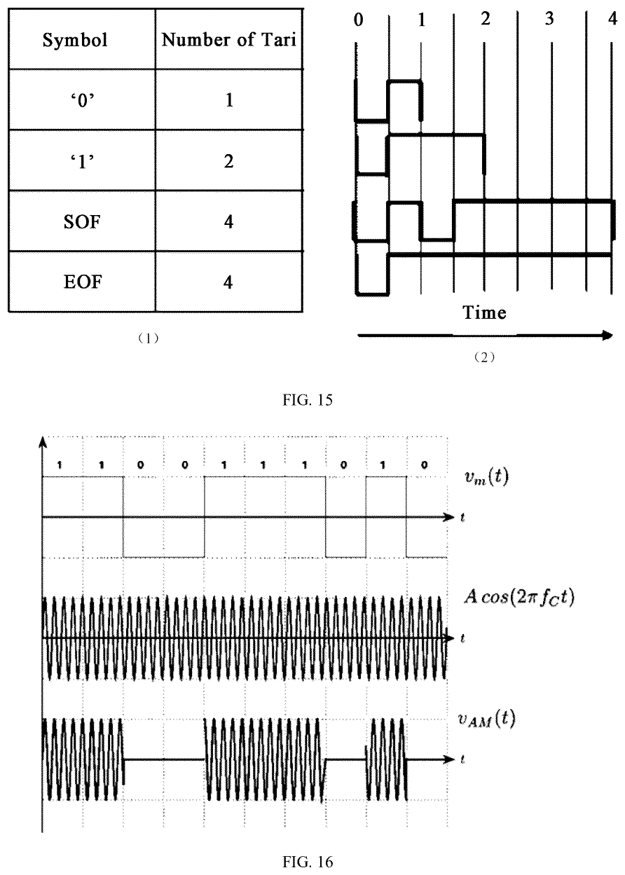

(10) Pulse width encoding (PWE). FIG. 15 shows a schematic diagram of pulse width encoding according to an embodiment of the present disclosure. As shown in FIG. 15, the principle of the pulse width encoding is to represent data by defining different time widths between falling edges of pulses. The data frame consists of an SOF (start of frame signal), an EOF (end of frame signal), data 0 and 1. Within the base time interval Tari interval, this time period is the time width between two adjacent pulse falling edges and lasts for 25 μs. In FIG. 15, (1) is the rule of pulse interval encoding, and (2) is a specific pulse schematic diagram.

In a possible implementation, the low-rate modulation scheme includes one of an on-off keying OOK modulation, a pulse modulation and a specific function modulation.

In an embodiment of the present disclosure, an on-off keying OOK modulation can set one amplitude of the signal to 0 and the other amplitude to non-zero, which is also known as binary amplitude shift keying (2ASK). The OOK modulation uses a unipolar non-return-to-zero code sequence to control on and off of a sinusoidal carrier.

Exemplarily, FIG. 16 shows a schematic diagram of a signal waveform of OOK modulation. As shown in FIG. 16, Vₘ(t) is a digital signal to be transmitted, Acos (2πf_{c}t) is an unmodulated carrier, and V_{AM}(t) is an OOK modulated carrier signal.

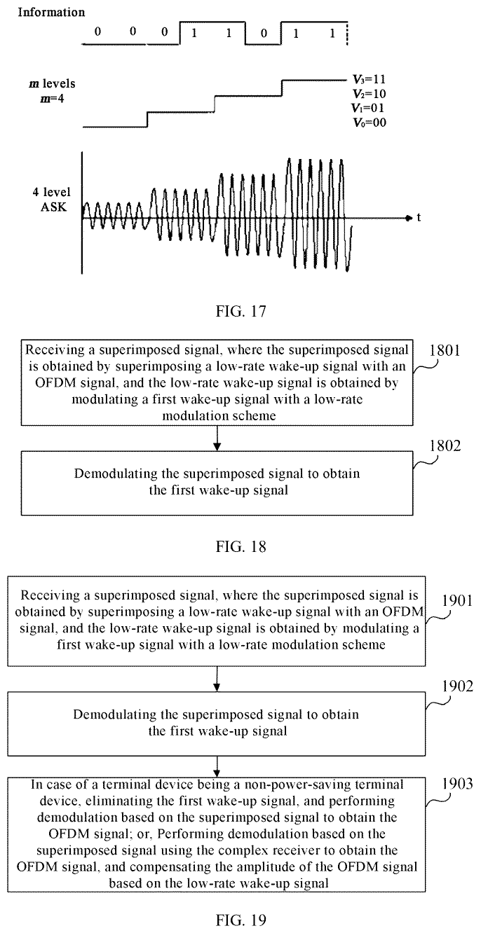

Exemplarily, FIG. 17 shows a schematic diagram of a signal waveform of amplitude shift keying (ASK) modulation. As shown in the FIG. 17, after modulation, the carrier can have 4 amplitudes (m=4), namely V₀=00, V₁=01, V₂=10, V₃=11. Each amplitude can represent 2 bits, so its transmission rate is twice that of OOK.

Pulse modulation can refer to a modulation scheme based on a pulse signal, which involves a simple amplitude variation. Specific function modulation refers to the process of modulating a signal based on various functions that can be flexibly configured. For example, the following formula (1) shows a specific form of a specific function:

$$x ( n ) = \{ \begin{matrix}a ( n ) + a ( n - \frac{N + {N}_{CP}}{2} ) , if B = 0 \\ a ( n ) - a ( n - \frac{N + {N}_{CP}}{2} ) , if B = 1\end{matrix} \qquad ( 1 )$$

In the above formula (1), when n is less than (N+N_{CP})/2, that is, n is 0, 1, 2, . . . , (N+N_{CP})/2−1, a(n) is equal to 1: when n is equal to or greater than (N+N_{CP})/2, a (n) is equal to 0. x(n) is the output value of the signal, and B can be a specific value in a single-bit indication. The specific calculation logic is as follows.

In the case that the single-bit indication bit is 0, when n is less than (N+N_{CP})/2, a(n) is equal to 1, and a (n−(N+N_{CP})/2) is 0: when n is equal to or greater than (N+N_{CP})/2, a (n) is equal to 0, and a (n−(N+N_{CP})/2) is 1. In this way, when the single-bit indication is 0, x(n) is always 1, and there is no amplitude conversion process.

In the case that the single-bit indication bit is 1, when n is less than (N+N_{CP})/2, a (n) is equal to 1, a (n−(N+N_{CP})/2) is 0, and x(n) is 1: when n is equal to or greater than (N+N_{CP})/2, a (n) is equal to 0, a (n−(N+N_{CP})/2) is 1, and x(n) is 0. Thus, when the single-bit indication is 1, x(n) undergoes an amplitude conversion process in the middle of the signal.

Of course, the specific function may also take other forms, and the low-rate modulation scheme may also be other modulation schemes beyond the above three methods, which are not limited in the embodiments of the present disclosure.

In an embodiment of the present disclosure, the first wake-up signal is modulated with the low-rate modulation scheme to obtain the low-rate wake-up signal. In this way, when reception is performed subsequently by the terminal device, the receiving method at the terminal device is relatively simple, and the judgment can be completed based on the amplitude of the waveform, which can be implemented by a low-complexity receiver, further reducing the energy consumption of the terminal device.

In a possible implementation, the superimposed signal is obtained by modulating the low-rate wake-up signal onto an OFDM signal on at least one symbol, and a time-domain waveform width of the low-rate wake-up signal is as same as a time-domain waveform width of the at least one symbol; and/or, the superimposed signal is obtained by superimposing the low-rate wake-up signal and a time-domain OFDM signal in a preconfigured frequency-domain resource.

The OFDM signal in the embodiment of the present disclosure may refer to an OFDM baseband time-domain waveform. In the 5G NR protocol, the time-domain waveform of OFDM is a signal after Inverse Fast Fourier Transform (IFFT). After the first wake-up signal is modulated with the low-rate modulation scheme, a time-domain waveform with equal amplitude, i.e., a low-rate wake-up signal, can be obtained, and the waveform width of the time-domain waveform of the low-rate wake-up signal can be the same as that of at least one symbol. Specifically, the low-rate wake-up signal may have one low-rate modulation symbol or may have multiple low-rate modulation symbols. Exemplarily, when the low-rate wake-up signal has three OOK modulation symbols, assuming that they are modulation symbol 1, modulation symbol 2, and modulation symbol 3 respectively, which can correspond to OFDM time-domain waveforms on the three symbols, assuming that they are symbol a, symbol b, and symbol c respectively. A network device can modulate modulation symbol 1 onto the OFDM time-domain waveform on symbol a, modulate modulation symbol 2 onto the OFDM time-domain waveform on symbol b, and modulate modulation symbol 3 onto the OFDM time-domain waveform on symbol c to achieve signal superimposition. In this way, the low-rate wake-up signal can be directly loaded onto or modulated onto the OFDM signal on at least one symbol, so as to achieve superimposition of the low-rate wake-up signal and the OFDM signal and obtain a superimposed signal.

Specifically, when forming the time-domain waveform of the OFDM signal, based on the content in the 3GPP protocol, the IFFT transformation can be performed as follows:

$${s}_{l}^{( p , μ )} ( t ) = \{ \begin{matrix}{\overline{s}}_{l}^{( p , μ )} ( t ) & {t}_{start , l}^{μ} \leq t < {t}_{start , l}^{μ} + {T}_{symb , l}^{μ} \\ 0 & otherwise\end{matrix} \qquad ( 2 )$$

$${\overline{s}}_{l}^{( p , μ )} ( t ) = {\sum }_{k = 0}^{{N}_{grid , x}^{size , μ} {N}_{sc}^{RB} - 1} {a}_{k , l}^{( p , μ )} {e}^{j2 π ( k + {k}_{0}^{μ} - {N}_{grid , x}^{size , μ} {N}_{sc}^{RB} / 2 ) Δ f ( t - {N}_{CP , l}^{μ} {T}_{c} - {t}_{start , l}^{μ} )} \qquad ( 3 )$$

$${k}_{0}^{μ} = ( {N}_{grid , x}^{start , μ} + {N}_{grid , x}^{size , μ} / 2 ) {N}_{SC}^{RB} - ( {N}_{grid , x}^{start , {μ}_{0}} + {N}_{grid , x}^{size , {μ}_{0}} / 2 ) {N}_{SC}^{RB} {2}^{{μ}_{0} - μ} \qquad ( 4 )$$

$${T}_{symb , l}^{μ} = ( {N}_{u}^{μ} + {N}_{CP , l}^{μ} ) {T}_{c} \qquad ( 5 )$$

$${N}_{u}^{μ} = 2048 κ \times {2}^{- μ} \qquad ( 6 )$$

$${N}_{CP , l}^{μ} = \{ \begin{matrix}512 κ \times {2}^{- μ} \\ 144 κ \times {2}^{- μ} + 16 κ \\ 144 κ \times {2}^{- μ}\end{matrix} \qquad ( 7 )$$

In the above formulas (2) to (7), α_{k,l}^{(p,μ)} is the data of the OFDM signal, the part to which ej2π belongs is used to calculate a position of a subcarrier in the frequency-domain, k is the position of the subcarrier, and

$${k}_{0}^{μ}$$

is a position of a start point. The subscript l of the signal s refers to the sign in the time-domain: the frequency-domain is k. The number of subcarriers is k from 0 to

$${N}_{grid , x}^{size , μ} {N}_{sc}^{RB} - 1 .$$

The equations above IFFT transformation can be clearly obtained in the 3GPP protocol, which will not be described in detail in the embodiments of the present disclosure.

It should be emphasized that in the embodiment of the present disclosure, taking the low-rate modulation scheme being OOK modulation as an example, the low-rate wake-up signal can be expressed as S_{wus-ook}(t), and the time-domain waveform of OFDM can be expressed as Sₗ^{(p,u)}(t), and the OFDM signal can be the time-domain waveform of the modulated data symbol. In this way, the low-rate wake-up signal can be transmitted without affecting the original data transmission of the network device, thereby improving the efficiency of data transmission. When the network device has no data for transmission, OFDM may be a time-domain waveform that does not include other data. After superimposing the low-rate wake-up signal with the OFDM signal, the superimposed signal can be expressed as S_{wus-ook}(t)+Sₗ^{(p,u)}(t), or S_{wus-ook}(t)*Sₗ^{(p,u)}(t) or S_{wus-ook}(t) Sₗ^{(p,u)}(t), etc., which is not limited in the embodiments of the present disclosure.

It should be noted that, in the time-domain, the low-rate wake-up signal may have the same time-domain waveform width as the OFDM signal, and the network device may superimpose the low-rate wake-up signal with the OFDM signal to obtain a superimposed signal. In the frequency-domain, the network device can superimpose the low-rate wake-up signal with a time-domain OFDM waveform in a preconfigured (predefined) frequency-domain resource to obtain a superimposed signal. The OFDM waveform in a predefined frequency-domain resource may refer to a time-domain OFDM waveform over 20 resource blocks (RB) of a synchronous broadcast signal SSB, etc. The embodiments of the present disclosure do not limit the specific form of the time-domain OFDM waveform in the frequency-domain resource.

In the following, several specific manners of superimposing a low-rate wake-up signal with an OFDM signal on at least one symbol according to the embodiments of the present disclosure will be described.

Manner 1: in a possible implementation, the at least one symbol is located within at least one time slot.

In the wireless interactive communication process between a terminal device and a network device, a wireless frame is a basic data transmission period of a wireless network, and a subframe is an allocation unit of uplink and downlink subframes. Exemplarily, a period of a radio frame is usually 10 milliseconds, and a period of a subframe may be 1 millisecond. Furthermore, a subframe may include multiple time slots, which may refer to a minimum unit for data scheduling and synchronization. Depending on whether there is a cyclic prefix (CP), a time slot may include 14 or 12 symbols. Among them, symbol is the basic unit of modulation and can be determined based on sub-carrier space (SCS). Since 5G NR provides a variety of subcarrier spacing, the frame structure of 5G is more flexible, and there are many situations for specific periods of time slots and subframes, which can be determined according to network configurations.

In an embodiment of the present disclosure, when a low-rate wake-up signal is superimposed on an OFDM signal, the low-rate wake-up signal may be loaded within at least one time slot of a time-domain waveform of the OFDM signal. That is, a network device may modulate the low-rate wake-up signal onto at least one symbol of the same time slot, or may modulate the low-rate wake-up signal onto several symbols of multiple time slots.

Manner 2: in a possible implementation, the at least one symbol is symbol(s) including a synchronous broadcast signal SSB: the low-rate wake-up signal is carried in at least one symbol including the synchronous broadcast signal SSB.

In an embodiment of the present disclosure, a synchronization broadcast signal (Synchronization Signal/PBCH, SSB) may refer to a signal used for network synchronization. A network device can transmit a synchronization broadcast signal SSB to a terminal device so that the terminal device can complete the synchronization with the network. When the at least one symbol is symbol(s) containing the synchronization broadcast signal SSB, the low-rate wake-up signal may be carried on the at least one symbol containing the synchronization broadcast signal SSB. For example, the SSB signal corresponds to 4 symbols, and the low-rate wake-up signal can be carried in at least one of the 4 symbols. Of course, the low-rate wake-up signal may also be carried on at least one other symbol of the time slot where the synchronous broadcast signal SSB is located, for example, carried on the last two symbols of the time slot where the SSB is located. The embodiments of the present disclosure do not limit the specific number of symbols and the specific position of the low-rate wake-up signal.

Manner 3, in a possible implementation, the at least one symbol is a symbol including system information SIB: the low-rate wake-up signal is carried in at least one symbol including the system information SIB.

In an embodiment of the present disclosure, system information SIB is system information broadcasted by a network device. Similarly, when the at least one symbol is a symbol containing the system information SIB, the low-rate wake-up signal may be carried on the at least one symbol containing the system information SIB. The low-rate wake-up signal may also be carried on at least one other symbol in the time slot where the system information SIB is located, which is not limited in the embodiments of the present disclosure.

In an embodiment of the present disclosure, in the time-domain, at least one symbol may be a symbol containing other signals, and the low-rate wake-up signal may be carried on at least one symbol containing other signals. In the frequency-domain, the time-domain OFDM waveform in the frequency-domain resource of a signal (such as SSB and SIB) can be superimposed with the low-rate wake-up signal to obtain a superimposed signal. In this way; the normal transmission of the low-rate wake-up signal can be guaranteed without affecting the normal data transmission of the network device, thereby allowing for the reuse of resources and reducing the power consumption of terminal devices.

In the following, the method of indicating the presence of the low-rate wake-up signal in the superimposed signal according to an embodiment of the present disclosure will be described.

In a possible implementation, whether the low-rate wake-up signal is present is indicated by system information SIB, downlink control information DCI, RRC or MAC-CE.

In an embodiment of the present disclosure, for the superimposed signal, a network device needs to inform a terminal device, through a specific indication, that the superimposed signal received includes a low-rate wake-up signal, that is, to indicate the presence of an LP-WUS signal. In R18, the existence of the LP-WUS can be indicated by system information SIB, downlink control information DCI, radio resource control RRC or media access control-control entity (MAC-CE), and specifically, 1 bit indication can be used. The embodiments of the present disclosure do not limit the specific ways for achieving the indication.

Specifically, the network device may indicate whether the low-rate wake-up signal is present through an information element in the system information SIB. When the information element in the SIB indicates true, at this time it shows that a superimposition of the low-rate wake-up signal is present in the signal received by the terminal device, that is, there is an LP-WUS signal. The network device may also indicate the presence of the LP-WUS signal in the superimposed signal through RRC signaling or MAC-CE.

In an embodiment of the present disclosure, the network device may also indicate whether a low-rate wake-up signal is present through downlink control information DCI. Specifically, the indication may be based on existing DCI. For example, a specific format in the DCI may be reused or adjusted to indicate the low-rate wake-up signal. Alternatively, a new DCI may be configured to implement the indication of the low-rate wake-up signal. Taking DCI format 2-1 as an example, there are two specific indication manners.

Manner 1: in a possible implementation, whether the low-rate wake-up signal is present is indicated by downlink control information DCI format 2-1 which has been scrambled by a new radio network temporary identifier RNTI.

In an embodiment of the present disclosure, a radio network temporary identity (RNTI) may be used to distinguish an identifier of a terminal device. Scrambling may refer to the process of multiplying the original signal by a pseudo-random code sequence, in order to encrypt the signal. In the original 3GPP standards and protocols, a user before R17 performs descrambling using his original RNTI to achieve original functions. In an embodiment of the present disclosure, a new RNTI can be configured to indicate whether the low-rate wake-up signal is present. The network device scrambles DCI format 2-1 μsing the new RNTI, and the terminal device descrambles DCI format 2-1 using the new RNTI, thereby achieving accurate indication of LP-WUS.

Manner 2: in a possible implementation, whether the low-rate wake-up signal is present is indicated by at least one bit newly added to the downlink control information DCI format 2-1.

In an embodiment of the present disclosure, the network device can add at least one bit on the basis of the original DCI format 2-1 to indicate whether the low-rate wake-up signal is present. For example, taking the example of adding 1 bit in DCI format 2-1, a value of 1 may be used to indicate a preemption indication, and a value of ( ) may be used to indicate the presence of an LP-WUS signal. Of course, multiple bits may be added to carry more information, which is not limited in the embodiments of the present disclosure.

When the network device uses SIB information element, DCI, RRC or MAC-CE to indicate whether the low-rate wake-up signal is present, the low-rate wake-up signal may be carried on a symbol where a specific signal is located. In this way, after determining that a low-rate wake-up signal is present, the terminal device can quickly locate at least one symbol where the low-rate wake-up signal is located.

Exemplarily, the low-rate wake-up signal can be carried on the last two symbols of the time slot where the SSB is located. At this time, after the terminal device determines that there is a low-rate wake-up signal based on the SIB information element, DCI, RRC or MAC-CE, it can quickly determine the two symbols where the low-rate wake-up signal is located, and then perform demodulation or compensation processing. The low-rate wake-up signal can also be carried on the symbol where the SSB is located, and at least one symbol corresponding to the low-rate wake-up signal can be the same as symbol(s) where the SSB is located. In this way, after the terminal device determines that a low-rate wake-up signal is present, it can perform demodulation or compensation processing based on the symbol where the SSB is located.

In addition, in a possible implementation, the DCI is further used to indicate a target position corresponding to the low-rate wake-up signal: the target position is at least one symbol where the low-rate wake-up signal is located in the OFDM signal.

In an embodiment of the present disclosure, DCI can also be used to indicate at least one symbol where a low-rate wake-up signal is located. For example, a network device may indicate the target location through DCI format 2-1, DCI format 2-1 is used for pre-emption indication (PI) in the original standard, and can indicate which symbols are punctured, i.e.

preempted, so that a terminal device skips these preempted symbols during processing. Of course, the network device may also use DCI in other formats to indicate the target location, which is not limited in the embodiments of the present disclosure. Exemplarily, the network device may indicate whether the low-rate wake-up signal is present through an SIB information element. When the SIB information element indicates true, DCI format 2-1 may indicate at least one symbol where the low-rate wake-up signal is located. In this way, the network device can reuse the function of DCI to indicate the target location of the low-rate wake-up signal, making the method of superimposing the low-rate wake-up signal with OFDM more flexible. It is no longer limited to carrying the low-rate wake-up signal on the symbol where the specific signal is located, thereby meeting the special needs of more actual scenarios.

On the basis of any of the above embodiments, the wake-up signal processing process is described in detail from the perspective of a terminal device in combination with the embodiment shown in FIG. 18.

FIG. 18 is a schematic flowchart of another wake-up signal processing method provided by an embodiment of the present disclosure. Referring to FIG. 18, the method may include:

S1801, receiving a superimposed signal, where the superimposed signal is obtained by superimposing a low-rate wake-up signal with an OFDM signal, and the low-rate wake-up signal is obtained by modulating a first wake-up signal with a low-rate modulation scheme.

In an embodiment of the present disclosure, the terminal device may receive a superimposed signal transmitted by a network device, and may subsequently demodulate the superimposed signal.

S1802, demodulating the superimposed signal to obtain the first wake-up signal.

In an embodiment of the present disclosure, due to the significant rate difference between the low-rate wake-up signal and the OFDM signal in the superimposed signal, the terminal device can obtain the two signals through demodulation. Afterwards, the terminal device can determine, based on the first wake-up signal, whether it needs to be awakened.

In the embodiment shown in FIG. 18, the terminal device receives a superimposed signal transmitted by the network device, the superimposed signal is obtained by superimposing a low-rate wake-up signal with an OFDM signal by the network device, and the low-rate wake-up signal is obtained by modulating a first wake-up signal with a low-rate modulation scheme by the network device. The terminal device demodulates the superimposed signal to obtain the first wake-up signal. Due to the significant rate difference between the low-rate wake-up signal and the OFDM signal, the terminal device can use a low-power demodulation scheme to demodulate the superimposed signal, reducing the power consumption of the terminal device: at the same time, on the basis of low power consumption, the terminal device can detect the wake-up signal more frequently, enabling real-time reception of the wake-up signal, thereby realizing rapid wake-up of the terminal device and meeting the requirements of delay-sensitive services.

On the basis of any of the above embodiments, the wake-up signal processing process is described in detail from the perspective of a terminal device in combination with the embodiment shown in FIG. 19.

FIG. 19 is a schematic flowchart of yet another wake-up signal processing method provided by an embodiment of the present disclosure. Referring to FIG. 19, the method may include:

S1901, receiving a superimposed signal, where the superimposed signal is obtained by superimposing a low-rate wake-up signal with an OFDM signal, and the low-rate wake-up signal is obtained by modulating a first wake-up signal with a low-rate modulation scheme:

S1902, demodulating the superimposed signal to obtain the first wake-up signal.

In a possible implementation, when the terminal device is a power-saving terminal device, the first wake-up signal is obtained by the power-saving terminal device through demodulation using a simple receiver.

In an embodiment of the present disclosure, the power-saving terminal device may refer to a terminal device with relatively higher requirements for energy efficiency, such as a sensor and an actuator. The simple receiver may refer to a receiver with low complexity or a receiver with low power consumption. The simple receiver can demodulate the superimposed signal in a simpler manner with lower power consumption. Since the low-rate wake-up signal is obtained by modulating the first wake-up signal with a low-rate modulation scheme, the simple receiver requires no IFFT transformation, resulting in low power consumption. It can detect the low-rate wake-up signal more frequently and remain in a detection state all the time, thereby allowing for real-time detection of the wake-up signal and quick waking up of the terminal device, meeting the needs of delay-sensitive services.

In a possible implementation, when the terminal device is a non-power-saving terminal device, the first wake-up signal is obtained by the non-power-saving terminal device through demodulating using a complex receiver.

In an embodiment of the present disclosure, the non-power-saving terminal device may refer to a terminal device that does not have high requirements for energy efficiency, such as some rechargeable 5G terminals. The non-power-saving terminal device can demodulate the OFDM signal using a common receiver or a complex receiver, so as to obtain data or control information transmitted from the network device side to the current terminal device, and realize normal data transmission.

It should be noted that the power-saving terminal device and the non-power-saving terminal device may be the same terminal device, but corresponding to two states of insufficient power and sufficient power of the terminal device. In a terminal device, a simple receiver and a complex receiver can be configured at the same time to meet the actual needs of the terminal device in different scenarios.

In a possible implementation, processing at the non-power-saving terminal is based on an indication of whether the low-rate wake-up signal is present in the superimposed signal.

In an embodiment of the present disclosure, when an OFDM signal includes symbol(s) containing other signal such as SSB or SIB, the superimposition of a low-rate wake-up signal at this time may have a negative impact on the original data signal, for example, it may affect the amplitude of the original data signal. Therefore, the non-power-saving terminal device can determine whether a low-rate wake-up signal is present based on an indication of system information SIB information element, downlink control information DCI, RRC or MAC-CE, and then perform corresponding compensation processing. For the specific indication method for the low-rate wake-up signal, reference can be made to the description on the network device side, which will not be repeated in the embodiments of the present disclosure.

S1903, in case of the terminal device being a non-power-saving terminal device, eliminating the first wake-up signal, and performing demodulation based on the superimposed signal to obtain the OFDM signal: or,
performing demodulation based on the superimposed signal using the complex receiver to obtain the OFDM signal, and compensating the amplitude of the OFDM signal based on the low-rate wake-up signal.

In an embodiment of the present disclosure, for a non-power-saving terminal device, after determining that a low-rate wake-up signal is present, the non-power-saving terminal device can quickly locate and demodulate the first wake-up signal in the low-rate wake-up signal, and eliminate this signal to eliminate the impact on original signal(s) in the OFDM signal, and then demodulate the OFDM signal, thereby ensuring the effectiveness of data reception. The non-power-saving terminal device can also divide the superimposed signal by the amplitude of the low-rate wake-up signal according to the amplitude of the low-rate wake-up signal, to perform amplitude compensation on the OFDM signal, thereby eliminating the impact of the low-rate wake-up signal on the OFDM signal.

Exemplarily, when the OFDM signal includes a symbol containing a synchronization broadcast signal SSB, if the low-rate wake-up signal is carried on the symbol containing the synchronization broadcast signal SSB, the non-power-saving terminal device needs to perform compensation processing on the symbol of the SSB. If the low-rate wake-up signal is only carried on the last two symbols of the time slot where the synchronous broadcast signal SSB is located, the non-power-saving terminal device needs to perform compensation processing on the signal carried on these two symbols in said time slot to ensure the normal transmission of original data between the network device and the terminal device.

It should be noted that after receiving the superimposed signal, the terminal device can adopt other methods to demodulate the superimposed signal based on actual conditions and actual needs to obtain the first wake-up signal, which is not limited in the embodiments of the present disclosure.

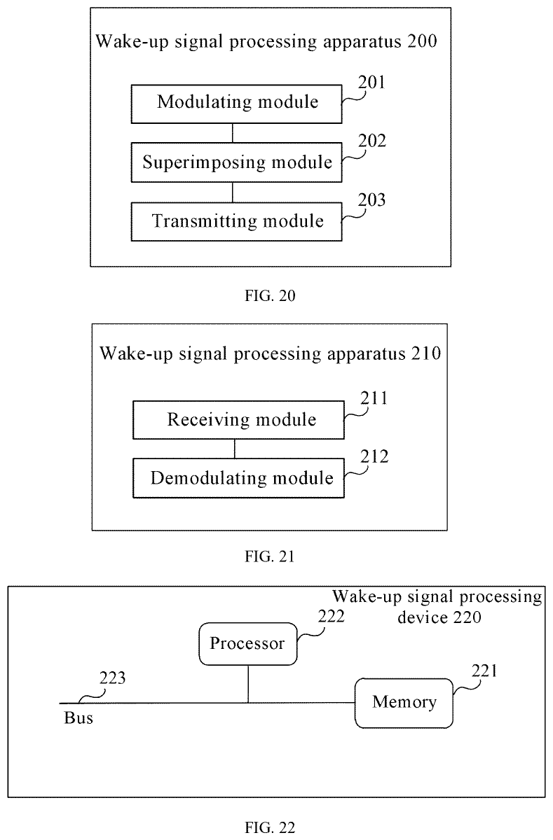

FIG. 20 is a structural schematic diagram of a wake-up signal processing apparatus provided by an embodiment of the present disclosure. Refer to FIG. 20, the wake-up signal processing apparatus 200 may include:
a modulating module 201, configured to modulate a first wake-up signal with a low-rate modulation scheme to obtain a low-rate wake-up signal;
a superimposing module 202, configured to superimpose the low-rate wake-up signal with an OFDM signal to obtain a superimposed signal;
a transmitting module 203, configured to transmit the superimposed signal.

The wake-up signal processing apparatus 200 provided in an embodiment of the present disclosure can execute the technical solution shown in the above method embodiments, and its implementation principle and beneficial effects are similar, which will not be repeated here.

In a possible implementation, the superimposed signal is obtained by modulating the low-rate wake-up signal onto an OFDM signal on at least one symbol, and a time-domain waveform width of the low-rate wake-up signal is as same as a time-domain waveform width of the at least one symbol; and/or,
the superimposed signal is obtained by superimposing the low-rate wake-up signal and a time-domain OFDM signal in a preconfigured frequency-domain resource.

In a possible implementation, the at least one symbol is located within at least one time slot.

In a possible implementation, the at least one symbol is a symbol including a synchronous broadcast signal SSB: the low-rate wake-up signal is carried in at least one symbol including the synchronous broadcast signal SSB.

In a possible implementation, the at least one symbol is a symbol including system information SIB: the low-rate wake-up signal is carried in at least one symbol including the system information SIB.

In a possible implementation, whether the low-rate wake-up signal is present is indicated by system information SIB, downlink control information DCI, RRC or MAC-CE.

In a possible implementation, whether the low-rate wake-up signal is present is indicated by DCI format 2-1, and the DCI format 2-1 is scrambled by a new radio network temporary identifier RNTI.

In a possible implementation, whether the low-rate wake-up signal is present is indicated by at least one bit newly added to the DCI format 2-1.

In a possible implementation, the DCI is further used to indicate a target position corresponding to the low-rate wake-up signal: the target position is at least one symbol where the low-rate wake-up signal is located in the OFDM signal.

In a possible implementation, the first wake-up signal includes a one-bit indication: or,
the first wake-up signal includes a one-bit indication and an identifier: the identifier includes at least one of an identifier of a terminal device or an identifier of a group to which a terminal device belongs.

In a possible implementation, the low-rate modulation scheme includes one of an on-off keying OOK modulation, a pulse modulation and a specific function modulation.

In a possible implementation, the first wake-up signal is a signal obtained after simple encoding.

In a possible implementation, the simple encoding includes any of the following:
non-return-to-zero encoding, Manchester encoding, unipolar return zero encoding, differential binary phase encoding, Miller encoding, modified Miller encoding, pulse interval encoding, pulse position encoding, bi-phase space encoding, pulse width encoding.

The wake-up signal processing apparatus 200 provided in an embodiment of the present disclosure can execute the technical solution shown in the above method embodiments, and its implementation principle and beneficial effects are similar, which will not be repeated here. The wake-up signal processing apparatus 200 may specifically be a chip, a chip module, etc., which is not limited in the embodiments of the present disclosure.

FIG. 21 is a structural schematic diagram of another wake-up signal processing apparatus provided by an embodiment of the present disclosure. Refer to FIG. 21, the wake-up signal processing apparatus 210 may include:
a receiving module 211, configured to receive a superimposed signal, where the superimposed signal is obtained by superimposing a low-rate wake-up signal with an OFDM signal, and the low-rate wake-up signal is obtained by modulating a first wake-up signal with a low-rate modulation scheme;
a demodulating module 212, configured to demodulate the superimposed signal to obtain the first wake-up signal.

The wake-up signal processing apparatus 210 provided in an embodiment of the present disclosure can execute the technical solution shown in the above method embodiments, and its implementation principle and beneficial effects are similar, which will not be repeated here. The wake-up signal processing apparatus 210 may specifically be a chip, a chip module, etc., which is not limited in the embodiments of the present disclosure.

FIG. 22 is a structural schematic diagram of a wake-up signal processing device provided by an embodiment of the present disclosure. Refer to FIG. 22, the wake-up signal processing device 220 may include a memory 221 and a processor 222. Exemplarily, the memory 221 and the processor 222 are interconnected via a bus 223.

The memory 221 is configured to store a program instruction.

The processor 222 is configured to execute the program instruction stored in the memory 221 to implement the wake-up signal processing method shown in the above embodiments.

The wake-up signal processing device shown in an embodiment of FIG. 22 can execute the technical solution shown in the above method embodiments, its implementation principles and beneficial effects are similar and will not be repeated here.

An embodiment of the present disclosure provides a non-transitory computer-readable storage medium storing a computer-executable instruction, when the computer-executable instruction is executed by a processor, the above-mentioned wake-up signal processing method is implemented.

An embodiment of the present disclosure also provides a computer program product including a computer program, when the computer program is executed by a processor, the above-mentioned wake-up signal processing method is implemented.

An embodiment of the present disclosure provides a chip storing a computer program, when the computer program is executed by the chip, the above-mentioned wake-up signal processing method is implemented.

An embodiment of the present disclosure also provides a chip module storing a computer program, when the computer program is executed by the chip module, the above-mentioned wake-up signal processing method is implemented.

It should be noted that the processor mentioned in the embodiments of the present disclosure may be a central processing unit (CPU), or other general-purpose processors, a digital signal processor (DSP), an application-specific integrated circuit (ASIC), a field programmable gate array (FPGA) or other programmable logic devices, a discrete gate or a transistor logic device, a discrete hardware component, etc. A general-purpose processor may be a microprocessor, or the processor may be any conventional processor or the like.

It should be understood that the memory mentioned in the embodiments of the present disclosure may be a volatile memory or a non-volatile memory, or may include both volatile and non-volatile memory. The non-volatile memory can be a read-only memory (ROM), a programmable read-only memory (programmable ROM, PROM), an erasable programmable read-only memory (erasable PROM, EPROM), an electrically erasable programmable read-only memory (electrically EPROM, EEPROM) or a flash memory. The volatile memory can be a random access memory (RAM), which acts as an external cache. By way of example and not limitation, many forms of RAM are available, such as static random-access memory (static RAM, SRAM), dynamic random-access memory (dynamic RAM, DRAM), synchronous dynamic random-access memory (synchronous DRAM, SDRAM), double data rate synchronous dynamic random-access memory (double data rate SDRAM, DDR SDRAM), enhanced synchronous dynamic random-access memory (enhanced SDRAM, ESDRAM), synchronous link dynamic random-access memory (synch link DRAM, SLDRAM) and direct memory bus random access memory (direct ram bus RAM, DR RAM). It should be noted that when the processor is a general-purpose processor, a DSP, an ASIC, an FPGA or other programmable logic devices, a discrete gate or a transistor logic device, a discrete hardware component, the memory (storage module) is integrated in the processor. It should be noted that the memory described herein is intended to include, but is not limited to, these and any other suitable types of memory.

The embodiments of the present disclosure are described with reference to a flowchart and/or a block diagram of a method, apparatus (system), and computer program product according to the embodiments of the present disclosure. It should be understood that each process and/or block in the flowchart and/or block diagram, as well as a combination of processes and/or blocks in the flowchart and/or block diagram, can be implemented by computer program instructions. These computer program instructions can be provided to a processing unit of a general purpose computer, a specialized computer, an embedded processing machine, or other programmable data processing devices to produce a machine so that the instructions executed through the processing unit of the computer or other programmable data processing device produce an apparatus for performing the functions specified in one or more processes in the flowchart and/or one or more blocks in the block diagrams.

These computer program instructions can also be stored in a non-transitory computer-readable memory capable of directing a computer or other programmable data-processing device to work in a particular manner so that the instructions stored in the non-transitory computer-readable memory result in a manufactured product including an instruction apparatus, where the instruction apparatus implements the functions specified in one or more processes in the flowchart and/or one or more blocks in the block diagrams.

These computer program instructions can also be loaded onto a computer or other programmable data processing device so that a series of operational steps are performed on the computer or other programmable device to produce computer-implemented processing, thereby the instructions executed on the computer or other programmable device provide steps for implementing the functions specified in one or more processes in the flowchart and/or one or more blocks in the block diagrams.

The modules/units contained in each device and product described in the above embodiments may be software modules/units or hardware modules/units, or may be partly software modules/units and partly hardware modules/units. Each device or product can be applied to or integrated into a chip, chip module or terminal. For example, for each device or product applied to or integrated in the chip, each module/chip contained therein may be implemented in the form of hardware such as circuits, or at least some modules/units may be implemented in the form of software programs, which run on the processor integrated inside the chip, and the remaining part of the modules/units can be implemented in the form of hardware such as a circuit.

Obviously, a person skilled in the art may make various changes and variants to the embodiments of the present disclosure without departing from the spirit and scope of the present disclosure. Thus, if these modifications and variants of the embodiments of the present disclosure fall within the scope of the claims of the present disclosure and equivalents thereof, the present disclosure is also intended to include such modifications and variants.

In the present disclosure, the term “include” and variations thereof may refer to a non-limiting inclusion: the term “or” and variations thereof may refer to “and/or”. In the present disclosure, the terms “first”, “second”, etc. are used to distinguish similar objects and are not necessarily used to describe a specific sequence or an order. In the present disclosure, “multiple” means two or more. “And/or” describes an association relationship of associated objects, and indicates that three relationships can exist. For example, A and/or B can mean that: A exists alone, A and B exist at the same time, and B exists alone. The character “/” generally indicates that previous and next associated objects are in an “or” relationship.

The present disclosure provides a wake-up signal processing method, apparatus and device, which reduce the energy consumption of terminal equipment while meeting the latency requirements.

In a first aspect, an embodiment of the present disclosure provides a wake-up signal processing method, including:
modulating a first wake-up signal with a low-rate modulation scheme to obtain a low-rate wake-up signal;
superimposing the low-rate wake-up signal with an orthogonal frequency division multiplexing OFDM signal to obtain a superimposed signal;
transmitting the superimposed signal.

In a possible implementation, the superimposed signal is obtained by modulating the low-rate wake-up signal onto an OFDM signal on at least one symbol, and a time-domain waveform width of the low-rate wake-up signal is as same as a time-domain waveform width of the at least one symbol; and/or,
the superimposed signal is obtained by superimposing the low-rate wake-up signal and a time-domain OFDM signal in a preconfigured frequency-domain resource.

In a possible implementation, the at least one symbol is located within at least one time slot.

In a possible implementation, the at least one symbol is a symbol including a synchronous broadcast signal SSB: the low-rate wake-up signal is carried in at least one symbol including the synchronous broadcast signal SSB.

In a possible implementation, the at least one symbol is a symbol including system information SIB: the low-rate wake-up signal is carried in at least one symbol including the system information SIB.

In a possible implementation, whether the low-rate wake-up signal is present is indicated by system information SIB, downlink control information DCI, radio resource control RRC or media access control-control entity MAC-CE.

In a possible implementation, whether the low-rate wake-up signal is present is indicated by DCI format 2-1, and the DCI format 2-1 is scrambled by a new radio network temporary identifier RNTI.

In a possible implementation, whether the low-rate wake-up signal is present is indicated by at least one bit newly added to the DCI format 2-1.

In a possible implementation, the DCI is further used to indicate a target position corresponding to the low-rate wake-up signal: the target position is at least one symbol where the low-rate wake-up signal is located in the OFDM signal.

In a possible implementation, the first wake-up signal includes a one-bit indication: or,
the first wake-up signal includes a one-bit indication and an identifier: the identifier includes at least one of an identifier of a terminal device or an identifier of a group to which a terminal device belongs.

In a possible implementation, the low-rate modulation scheme includes one of an on-off keying OOK modulation, a pulse modulation and a specific function modulation.

In a possible implementation, the first wake-up signal is a signal obtained after simple encoding.

In a possible implementation, the simple encoding includes any of the following:
non-return-to-zero encoding, Manchester encoding, unipolar return zero encoding, differential binary phase encoding, Miller encoding, modified Miller encoding, pulse interval encoding, pulse position encoding, bi-phase space encoding, pulse width encoding.

In a second aspect, an embodiment of the present disclosure provides a wake-up signal processing method, including:
receiving a superimposed signal, where the superimposed signal is obtained by superimposing a low-rate wake-up signal with an orthogonal frequency division multiplexing OFDM signal, and the low-rate wake-up signal is obtained by modulating a first wake-up signal with a low-rate modulation scheme;
demodulating the superimposed signal to obtain the first wake-up signal.

In a possible implementation, the superimposed signal is obtained by modulating the low-rate wake-up signal onto an OFDM signal on at least one symbol, and a time-domain waveform width of the low-rate wake-up signal is as same as a time-domain waveform width of the at least one symbol; and/or,
the superimposed signal is obtained by superimposing the low-rate wake-up signal and a time-domain OFDM signal in a preconfigured frequency-domain resource.

In a possible implementation, the at least one symbol is located within at least one time slot.

In a possible implementation, the at least one symbol is a symbol including a synchronous broadcast signal SSB: the low-rate wake-up signal is carried in at least one symbol including the synchronous broadcast signal SSB.

In a possible implementation, the at least one symbol is a symbol including system information SIB: the low-rate wake-up signal is carried in at least one symbol including the system information SIB.

In a possible implementation, whether the low-rate wake-up signal is present is indicated by system information SIB, downlink control information DCI, radio resource control RRC or media access control-control entity MAC-CE.

In a possible implementation, whether the low-rate wake-up signal is present is indicated by DCI format 2-1, and the DCI format 2-1 is scrambled by a new radio network temporary identifier RNTI.

In a possible implementation, whether the low-rate wake-up signal is present is indicated by at least one bit newly added to the DCI format 2-1.

In a possible implementation, the DCI is further used to indicate a target position corresponding to the low-rate wake-up signal: the target position is at least one symbol where the low-rate wake-up signal is located in the OFDM signal.

In a possible implementation, the first wake-up signal includes a one-bit indication: or,
the first wake-up signal includes a one-bit indication and an identifier: the identifier includes at least one of an identifier of a terminal device or an identifier of a group to which a terminal device belongs.

In a possible implementation, the low-rate modulation scheme includes one of an on-off keying OOK modulation, a pulse modulation and a specific function modulation.

In a possible implementation, the first wake-up signal is a signal obtained after simple encoding.

In a possible implementation, the simple encoding includes any of the following: non-return-to-zero encoding, Manchester encoding, unipolar return zero encoding, differential binary phase encoding, Miller encoding, modified Miller encoding, pulse interval encoding, pulse position encoding, bi-phase space encoding, pulse width encoding.

In a third aspect, an embodiment of the present disclosure provides a wake-up signal processing apparatus, including:
a modulating module, configured to modulate a first wake-up signal with a low-rate modulation scheme to obtain a low-rate wake-up signal;
a superimposing module, configured to superimpose the low-rate wake-up signal with an orthogonal frequency division multiplexing OFDM signal to obtain a superimposed signal;
a transmitting module, configured to transmit the superimposed signal.

In a possible implementation, the superimposed signal is obtained by modulating the low-rate wake-up signal onto an OFDM signal on at least one symbol, and a time-domain waveform width of the low-rate wake-up signal is as same as a time-domain waveform width of the at least one symbol; and/or,
the superimposed signal is obtained by superimposing the low-rate wake-up signal and a time-domain OFDM signal in a preconfigured frequency-domain resource.

In a possible implementation, the at least one symbol is located within at least one time slot.

In a possible implementation, the at least one symbol is a symbol including a synchronous broadcast signal SSB: the low-rate wake-up signal is carried in at least one symbol including the synchronous broadcast signal SSB.

In a possible implementation, the at least one symbol is a symbol including system information SIB: the low-rate wake-up signal is carried in at least one symbol including the system information SIB.

In a possible implementation, whether the low-rate wake-up signal is present is indicated by system information SIB, downlink control information DCI, radio resource control RRC or media access control-control entity MAC-CE.

In a possible implementation, whether the low-rate wake-up signal is present is indicated by DCI format 2-1, and the DCI format 2-1 is scrambled by a new radio network temporary identifier RNTI.

In a possible implementation, whether the low-rate wake-up signal is present is indicated by at least one bit newly added to the DCI format 2-1.

In a possible implementation, the DCI is further used to indicate a target position corresponding to the low-rate wake-up signal: the target position is at least one symbol where the low-rate wake-up signal is located in the OFDM signal.

In a possible implementation, the first wake-up signal includes a one-bit indication: or, the first wake-up signal includes a one-bit indication and an identifier: the identifier includes at least one of an identifier of a terminal device or an identifier of a group to which a terminal device belongs.

In a possible implementation, the low-rate modulation scheme includes one of an on-off keying OOK modulation, a pulse modulation and a specific function modulation.

In a possible implementation, the first wake-up signal is a signal obtained after simple encoding.

In a possible implementation, the simple encoding includes any of the following:
non-return-to-zero encoding, Manchester encoding, unipolar return zero encoding, differential binary phase encoding, Miller encoding, modified Miller encoding, pulse interval encoding, pulse position encoding, bi-phase space encoding, pulse width encoding.

In a fourth aspect, an embodiment of the present disclosure provides a wake-up signal processing apparatus, including:
a receiving module, configured to receive a superimposed signal, where the superimposed signal is obtained by superimposing a low-rate wake-up signal with an orthogonal frequency division multiplexing OFDM signal, and the low-rate wake-up signal is obtained by modulating a first wake-up signal with a low-rate modulation scheme;
a demodulating module, configured to demodulate the superimposed signal to obtain the first wake-up signal.

In a fifth aspect, an embodiment of the present disclosure provides a wake-up signal processing device, including a processor and a memory:
the memory stores a computer-executable instruction;
the processor executes the computer-executable instruction stored in the memory to implement the method as described in any one of the first aspect or the second aspect.

In a sixth aspect, an embodiment of the present disclosure provides a non-transitory computer-readable storage medium which stores a computer-executable instruction, when the computer-executable instruction is executed, the method as described in any one of the first aspect or the second aspect is implemented.

In a seventh aspect, an embodiment of the present application provides a computer program product which includes a computer program, when the computer program is executed, the method as described in any one of the first aspect or the second aspect is implemented.

In an eighth aspect, an embodiment of the present application provides a chip which stores a computer program, when the computer program is executed by the chip, the method as described in any one of the first aspect or the second aspect is implemented.

In a ninth aspect, an embodiment of the present application provides a chip module which stores a computer program, when the computer program is executed by the chip module, the method as described in any one of the first aspect or the second aspect is implemented.

The present disclosure provides a wake-up signal processing method, apparatus and device. A network device modulates a first wake-up signal with a low-rate modulation scheme to obtain a low-rate wake-up signal, superimposes the low-rate wake-up signal with an OFDM signal to obtain a superimposed signal, and transmits the superimposed signal to a terminal device. In this way, due to the significant rate difference between the low-rate wake-up signal and the OFDM signal, the terminal device can demodulate the superimposed signal with a low-power demodulation scheme, thereby reducing power consumption of the terminal device. In addition, on the basis of low power consumption, the terminal device can detect the wake-up signal more frequently, enabling real-time reception of the wake-up signal, thereby realizing rapid wake-up of the terminal device and meeting the requirements of delay-sensitive services.

1. A wake-up signal processing method, comprising:
modulating a first wake-up signal with a low-rate modulation scheme to obtain a low-rate wake-up signal;
superimposing the low-rate wake-up signal with an orthogonal frequency division multiplexing (OFDM) signal to obtain a superimposed signal;
transmitting the superimposed signal.

2. The method according to claim 1, wherein the superimposed signal is obtained by modulating the low-rate wake-up signal onto an OFDM signal on at least one symbol, and a time-domain waveform width of the low-rate wake-up signal is as same as a time-domain waveform width of the at least one symbol; and/or,
the superimposed signal is obtained by superimposing the low-rate wake-up signal and a time-domain OFDM signal in a preconfigured frequency-domain resource.

3. The method according to claim 2, wherein the at least one symbol is located within at least one time slot.

4. The method according to claim 2, wherein the at least one symbol is a symbol comprising a synchronous broadcast signal (SSB); the low-rate wake-up signal is carried in at least one symbol comprising the SSB.

5. The method according to claim 2, wherein the at least one symbol is a symbol comprising system information (SIB): the low-rate wake-up signal is carried in at least one symbol comprising the SIB.

6. The method according to claim 1, wherein whether the low-rate wake-up signal is present is indicated by system information (SIB), downlink control information (DCI), radio resource control (RRC) or media access control-control entity (MAC-CE).

7. The method according to claim 6, wherein whether the low-rate wake-up signal is present is indicated by DCI format 2-1, and the DCI format 2-1 is scrambled by a new radio network temporary identifier (RNTI).

8. The method according to claim 67, whether the low-rate wake-up signal is present is indicated by at least one bit newly added to the DCI format 2-1.

9. The method according to claim 6, wherein the DCI is further used to indicate a target position corresponding to the low-rate wake-up signal: the target position is at least one symbol where the low-rate wake-up signal is located in the OFDM signal.

10. The method according to claim 1, wherein the first wake-up signal comprises a one-bit indication; or,
the first wake-up signal comprises a one-bit indication and an identifier; the identifier comprises at least one of an identifier of a terminal device or an identifier of a group to which a terminal device belongs.

11. The method according to claim 1, wherein the low-rate modulation scheme comprises one of an on-off keying (OOK) modulation, a pulse modulation and a specific function modulation.

12. The method according to claim 1, wherein the first wake-up signal is a signal obtained after simple encoding.

13. The method according to claim 12, wherein the simple encoding comprises any one of following items:
non-return-to-zero encoding, Manchester encoding, unipolar return zero encoding, differential binary phase encoding, Miller encoding, modified Miller encoding, pulse interval encoding, pulse position encoding, bi-phase space encoding, pulse width encoding.

14. A wake-up signal processing method, comprising:
receiving a superimposed signal, wherein the superimposed signal is obtained by superimposing a low-rate wake-up signal with an orthogonal frequency division multiplexing (OFDM) signal, and the low-rate wake-up signal is obtained by modulating a first wake-up signal with a low-rate modulation scheme;
demodulating the superimposed signal to obtain the first wake-up signal.

15. (canceled)

16. (canceled)

17. A wake-up signal processing device, comprising a processor and a memory:
the memory stores a computer-executable instruction;
the processor executes the computer-executable instruction stored in the memory to;
modulate a first wake-up signal with a low-rate modulation scheme to obtain a low-rate wake-up signal;
superimpose the low-rate wake-up signal with an orthogonal frequency division multiplexing (OFDM) signal to obtain a superimposed signal;
transmit the superimposed signal.

18. A non-transitory computer-readable storage medium storing a computer-executable instruction, wherein when the computer-executable instruction is executed, the method according to claim 1 is implemented.

19. (canceled)

20. (canceled)

21. A wake-up signal processing device, comprising a processor and a memory:
the memory stores a computer-executable instruction;
the processor executes the computer-executable instruction stored in the memory to implement the method according to claim 14.

22. The wake-up signal processing device according to claim 17, wherein the superimposed signal is obtained by modulating the low-rate wake-up signal onto an OFDM signal on at least one symbol, and a time-domain waveform width of the low-rate wake-up signal is as same as a time-domain waveform width of the at least one symbol; and/or,
the superimposed signal is obtained by superimposing the low-rate wake-up signal and a time-domain OFDM signal in a preconfigured frequency-domain resource.

23. The wake-up signal processing device according to claim 17, wherein whether the low-rate wake-up signal is present is indicated by system information (SIB), downlink control information (DCI), radio resource control (RRC) or media access control-control entity (MAC-CE).

24. The wake-up signal processing device according to claim 17, wherein the first wake-up signal comprises a one-bit indication; or,
the first wake-up signal comprises a one-bit indication and an identifier; the identifier comprises at least one of an identifier of a terminal device or an identifier of a group to which a terminal device belongs.
